(19) United States
(12) Patent Application Publication
(10) Pub. No.: US 2009/0313631 A1
(43) Pub. Date: Dec. 17, 2009

(54) AUTONOMIC WORKLOAD PLANNING

(76) Inventors: Fabio De Marzo, Bari (BA) (IT); Antonio Di Cocco, Rome (IT); Domenico Di Giulio, Roma (IT); Franco Mossotto, Roma (IT)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 12/136,813

(22) Filed: Jun. 11, 2008

(51) Int. Cl. G06F 9/46

(52) U.S. Cl. 718/103; 718/102

(57) ABSTRACT

A method of automatically optimizing workload scheduling. Target values for workload characteristics and constraint specifications are received. Generation of a first execution plan is initiated. Initial constraint values conforming to the constraint specifications are selected. Each constraint value constrains tasks included in the workload. The first execution plan is executed, thereby determining measurements of workload characteristics. Contributions indicating differences between workload characteristic measurements and target values are determined and stored. Generation of a next execution plan is initiated. Modified constraint values conforming to the constraint specifications are selected. Changes in the workload characteristics based on the modified constraint values are evaluated. An optimal or acceptable sub-optimal solution in a space of solutions defined by the constraint specifications is determined, resulting in new values for the constraints. After replacing the initial values with the new values, the next execution plan is generated and executed.

### FIELD OF THE INVENTION

The present invention relates to workload scheduling systems and more particularly to a data processing method and system for automatically optimizing workload scheduling.

### BACKGROUND OF THE INVENTION

Workload scheduling systems provide a means for scheduling a complex set of automated tasks on the machines of an information technology (IT) infrastructure, ensuring that each task is executed on time only when any dependency or prerequisite condition is met. To provide such assurances upon execution of each task, a conventional workload scheduling system allows the definition of tasks to be executed together with a set of rules to be met for creating an execution plan. The workload scheduling system elaborates the rules, considering time dependencies and any other constraint, and builds a plan whose execution is monitored by a user. By human intervention via a manual review of information included in execution reports, a user attempts to understand the workload and determine actions to take to optimize resource consumption as much as possible. The manual activities of reviewing the execution reports, analyzing the workload and determining the optimization actions to take are time consuming and error prone. Furthermore, known monitoring systems can take action at plan execution time, thereby dynamically reacting to conditions of non-optimal resource usage. These conventional monitoring systems, however, cannot prevent the same conditions from appearing again in the future. Thus, there exists a need to overcome at least one of the preceding deficiencies and limitations of the related art.

### SUMMARY OF THE INVENTION

The present invention provides a computer-implemented method of automatically optimizing workload scheduling. A computing system receives user-defined target values for predefined workload characteristics. The target values are characteristics of a workload in an information technology infrastructure. The computing system receives user-defined constraint specifications. Each constraint specification includes a range of values or a set of values. After receiving the constraint specifications and the target values, the computing system initiates a generation of a first execution plan. After initiating the generation of the first execution plan, the computing system selects a set of initial values for constraints. Each constraint is specified by one of the constraint specifications. Each constraint constrains tasks included in the workload. After selecting the set of initial values, the computing system generates and then executes the first execution plan. Executing the first execution plan includes determining measurements of the workload characteristics. After executing the first execution plan, the computing system determines a set of contributions, each contribution indicating a difference between one of the measurements of the workload characteristics and one of the target values. After determining the contributions, the computing system stores the contributions in a computer data storage unit. After determining the contributions, the computing system initiates a generation of a next execution plan. After initiating the generation of the next execution plan, the computing system modifies the constraints, resulting in a set of modified values of the constraints. Each modified value is specified by one of the constraint specifications. After modifying the constraints, the computing system evaluates changes in the workload characteristics. The changes are based on the set of modified values of the constraints for each time period of a set of predefined time periods in a duration of the next execution plan. After evaluating the changes, the computing system determines an optimal solution or an acceptable sub-optimal solution in a space of solutions defined by the constraint specifications, resulting in a set of new values for the constraints. After determining the optimal solution or the sub-optimal solution, the computing system stores, in a computer data storage medium, the set of new values for the constraints. After determining the optimal solution or the sub-optimal solution, the computing system replaces the set of initial values with the set of new values. After replacing the set of initial values, the computing system generates the next execution plan. The next execution plan includes the set of new values as the constraints. After generating the next execution plan, the computing system executes the next execution plan.

A system and a computer program product corresponding to the above-summarized methods are also described and claimed herein.

### BRIEF DESCRIPTION OF THE DRAWINGS

FIG. 1 is a block diagram of a system for automatically optimizing workload scheduling, in accordance with embodiments of the present invention.

FIGS. 2A-2B depict a flowchart of an automatic workload scheduling optimization process implemented by the system of FIG. 1, in accordance with embodiments of the present invention.

FIG. 3 is a computing system that is included in the system of FIG. 1 and that implements the process of FIGS. 2A-2B, in accordance with embodiments of the present invention.

### DETAILED DESCRIPTION OF THE INVENTION

### Overview

An embodiment of the present invention provides a user-defined and automatic optimization of workload scheduling (i.e., workload planning) in an IT infrastructure via an autonomic system and process that modifies the shape of an execution plan (a.k.a. workload execution plan). The automatic workload scheduling optimization system and process disclosed herein is based on a set of measurements that are taken at execution time to determine each single task's contribution to the overall workload. After collecting the information about the tasks' contributions, the system automatically determines how to change scheduling definitions so that the workload is optimized as requested by the user. As used herein, an “execution plan” is defined as a list of automated tasks scheduled for execution on a variety of computer systems in a predefined time frame. The execution plan includes information about tasks to be executed as well as information about time constraints and dependencies from physical or logical resources that are required by each task to complete. As used herein, “workload” is defined as the resource utilization generated by the tasks of an execution plan.

### System for Automatically Otpimizing Workload Scheduling

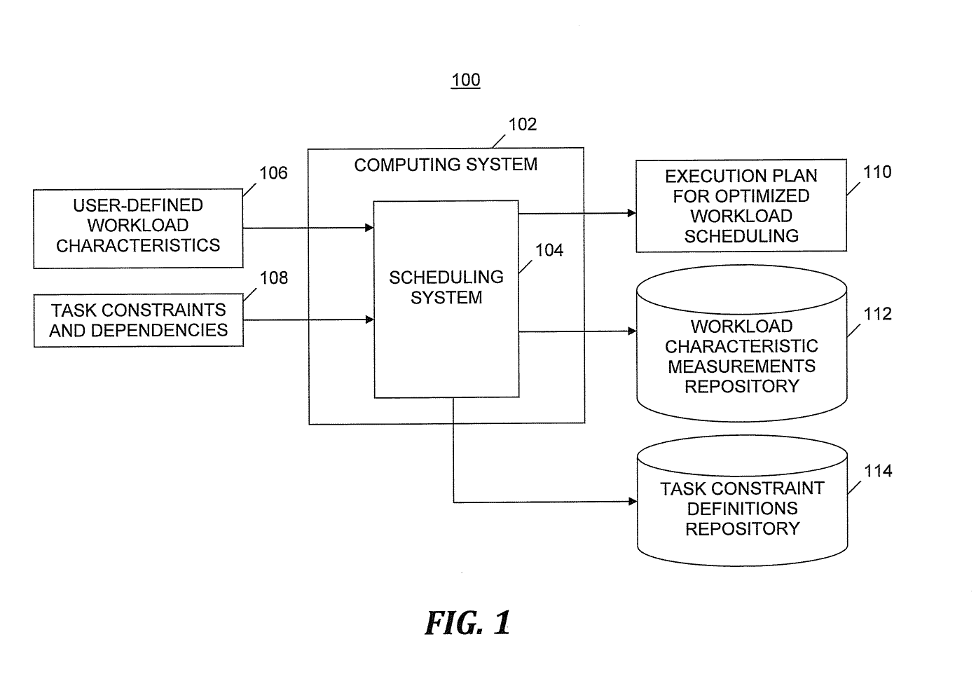

FIG. 1 is a block diagram of a system for automatically optimizing workload scheduling, in accordance with embodiments of the present invention. System 100 includes a computing system 102 that includes a scheduling system 104. System 100 also includes user-defined values for workload characteristics 106, user-defined values for task constraints and dependencies 108, an execution plan for optimized workload scheduling 110, a workload characteristic measurements repository 112 and a task constraint definitions repository 114. Repositories 112 and 114 reside in one or more computer data storage devices that may be coupled to computing system 102 or to another computing system (not shown) in communication with computing system 102 via a network (not shown).

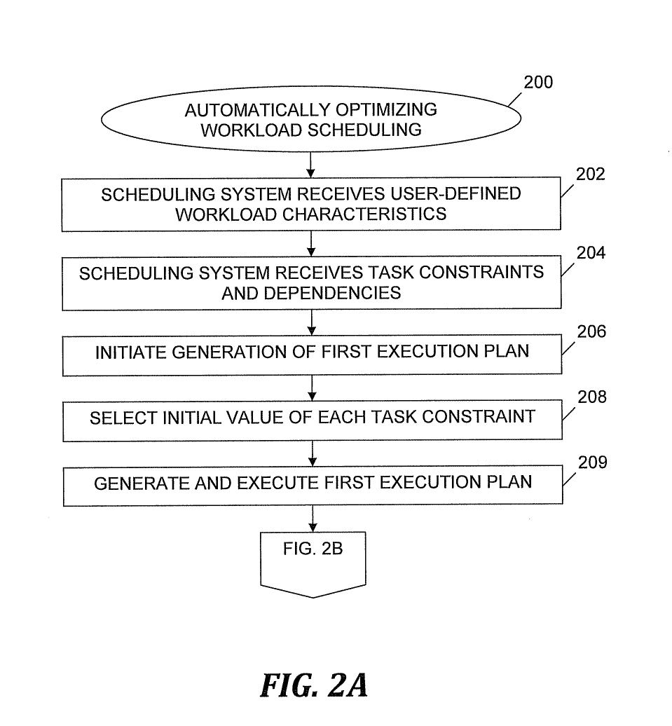

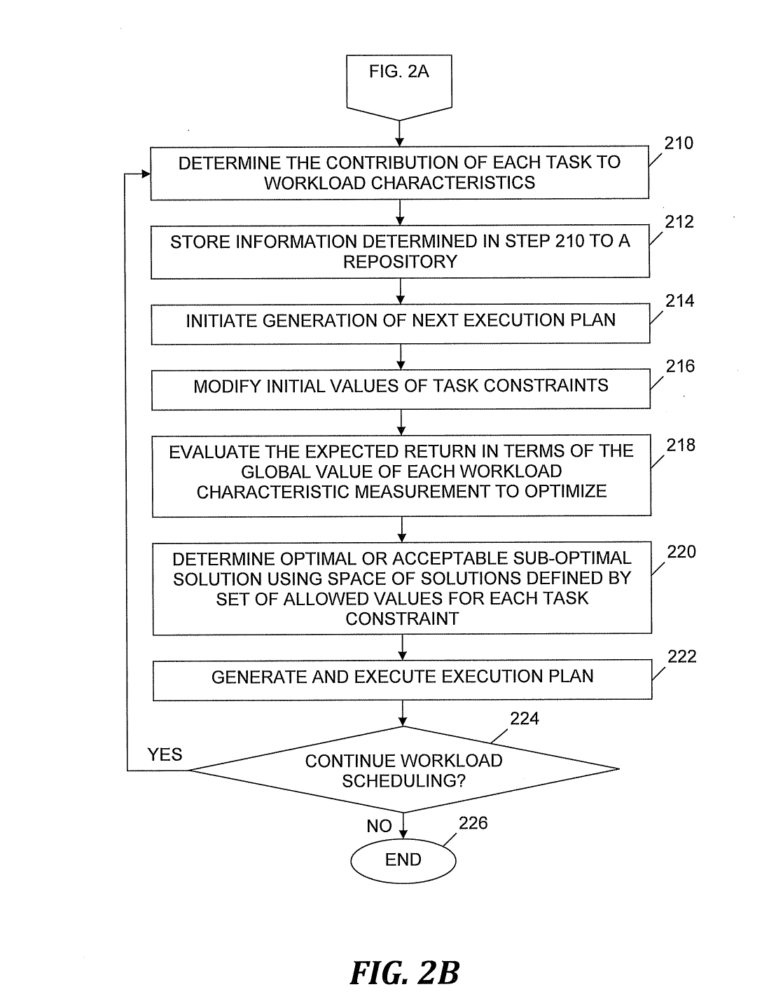

User-defined values for workload characteristics 106 and user-defined values for task constraints and dependencies 108 are entered by user(s) as input to scheduling system 104. Repository 112 stores data related to workload characteristics, including measurements of workload characteristics and evaluated contributions of tasks to workload characteristics. Repository 114 stores definitions of task constraints. The output of scheduling system 104 is an optimized execution plan 110. The functionality of the components of system 100 is described in more detail below relative to FIGS. 2A-2B.

### Process for Automatically for Optimizing Workload Scheduling

FIGS. 2A-2B depict a flowchart of an automatic workload scheduling optimization process implemented by the system of FIG. 1, in accordance with embodiments of the present invention. The workload scheduling optimization process begins at step 200. In step 202, scheduling system 104 (see FIG. 1) requests that a user of computing system 102 (see FIG. 1) enter target (i.e., desired) values for multiple characteristics of a desired workload (i.e., values for workload characteristics 106 of FIG. 1). The user enters the target values on a set of measurements for a user-defined timeframe. Also in step 202, scheduling system 104 (see FIG. 1) receives the user-defined workload characteristics 106 (see FIG. 1). In one embodiment, the user-defined workload characteristics 106 (see FIG. 1) that are entered and received in step 202 include one or more of the following values:

1. The average number of tasks executed per unit of time

2. The central processing unit (CPU) usage (i.e., consumption)

3. The memory consumption

4. The input/output (I/O) read/write rate

For example, in step 202, the user enters 50% for CPU usage, 512 MB for memory usage, etc.

In step 204, the user sets values for constraints and/or dependencies 108 (see FIG. 1) for each task to be executed in the workload. Rather than entering defined values, the constraints (a.k.a. task constraints) and dependencies 108 (see FIG. 1) are entered by the user in step 204 by specifying allowed ranges or sets of values, thereby allowing a degree of flexibility in how the constraints and dependencies are defined. For example, the following parameters that are typically defined together with a task or a task group of a scheduling system are defined in a flexible way (i.e., as a range or a set of values):
1. The date and/or time when the task is expected to run is defined as being within a range of dates and/or a range of times instead of a fixed value.
2. The frequency rate for tasks that are executed repeatedly varies from a minimum value to a maximum value.
3. The priority of a task is defined as a maximum value or a minimum value rather than as a defined value.

Also in step 204, scheduling system 104 (see FIG. 1) receives the user-defined constraints and/or dependencies 108 (see FIG. 1).

In step 206, scheduling system 104 (see FIG. 1) initiates generating a first execution plan for the workload. In step 208, scheduling system 104 (see FIG. 1) selects an initial value for each constraint defined in step 204, where the selected initial value is within the range or set defined in step 204. For example, a task is scheduled to start between 8:00 AM and 10:00 AM and the scheduling system selects 9:00 AM as the initial constraint value. In step 209, scheduling system 104 (see FIG. 1) generates the first execution plan with the values selected in step 208 for each of the constraints defined in step 204. Also in step 209, the execution plan runs on target computing systems. The workload scheduling optimization process continues in FIG. 2B.

In step 210 of FIG. 2B, after the execution of the execution plan is completed, scheduling system 104 (see FIG. 1) compares values of workload characteristics resulting from the execution plan with the target values defined in step 202 (see FIG. 2A). Using facilities of an operating system of a computing system on which the tasks are run, the scheduling system determines contributions in each time period of multiple predefined time periods that comprise the entire duration of the execution plan. Each contribution determined in step 210 is a value that indicates how much a task contributes to an increase or a decrease in each of the measurements of the workload characteristics defined in step 202 of FIG. 2A, where the increase or decrease is measured for one of the predefined time periods.

As one example, the scheduling system in step 210 calculates the CPU usage or memory consumption of each task in every minute, in addition to the start time and duration and other typical measurements. As another example, the scheduling system knows that a CPU was used 25% of the time by task A and 33% of the time by task B, for a total CPU consumption of 58%. This measurement of CPU consumption is calculated separately in multiple predefined time periods within the entire duration of the execution plan. For instance, an execution plan whose duration is 2 hours is divided into 24 time periods each 5 minutes in length. For each of these 5-minute time periods, the scheduling system determines the average CPU consumption for each task run within that 5-minute time period.

In step 212, scheduling system 104 (see FIG. 1) collects the contributions determined in step 210 on a task basis and stores this collected information in a centralized database (e.g., repository 112 of FIG. 1) residing in a computer data storage unit. Optionally, scheduling system 104 (see FIG. 1) presents the contributions determined in step 210 to a user (e.g., via an ad hoc report printed by a printing device or displayed on a display device). For example, a user may review the presented information about the contributions to facilitate understanding the resource consumption on a task basis and to thereby change task definitions to reduce overhead and bottlenecks. It should be noted that a user will not use this information about contributions to choose other constraint values, as these values are chosen automatically by the process of FIGS. 2A-2B.

In step 214, scheduling system 104 (see FIG. 1) starts the process that generates a next workload execution plan for a timeframe that is different from the timeframe of the most recently executed workload execution plan. For example, the generation of the next workload execution plan is initiated for a new day because execution plans are generated on a daily basis.

In step 216, scheduling system 104 (see FIG. 1) simulates a change of each constraint value used in the most recently executed workload execution plan by selecting other constraint values in the ranges and/or sets of values defined in step 204 (see FIG. 2A). The first time step 216 is performed in the process of FIGS. 2A-2B, the selection of other constraint values in step 216 modifies the initial values of the task constraints that were selected in step 208 (see FIG. 2A). In subsequent performances of step 216, the scheduling system 104 (see FIG. 1) modifies the values of task constraints that were selected in the most recent previous performance of step 216. The scheduling system stores the modified task constraints resulting from step 216 in repository 114 (see FIG. 1), which resides in a computer data storage unit.

In step 218, by using the constraint values selected in step 216, scheduling system 104 (see FIG. 1) determines an expected impact of a global value of each workload characteristic measurement being optimized, considering the data collected at the most recent execution of a workload execution plan (e.g., see step 209 of FIG. 2A and step 222 described below). The determination of the expected impact in step 218 is performed in advance of executing a new execution plan. In step 218, the scheduling system calculates the change in the workload characteristics produced by the change of task constraint values selected in step 216. The calculation in step 218 includes calculating a new value of each workload characteristic for predefined time periods in the timeframe for the next execution plan, considering the new value selected for every constraint in step 216.

Continuing the example presented above relative to step 210, if task A is anticipated in a way that it no longer overlaps with task B (i.e., based on the estimated duration of the task itself, which is known from the execution plan results), then CPU consumption may never be raised to 58%. On the other hand, if task A is anticipated based on the ranges and/or sets of values defined for time constraints in step 204 (see FIG. 2A), but the overlap with task B cannot be completely avoided, then there will be a lower number of time periods in which CPU consumption is 58%. In both cases in this example, anticipation is desirable if the user desires a maximum CPU consumption of 50%.

In step 220, using one or more algorithms (e.g., the “Greedy” algorithm or the “Branch and Bound” algorithm) for searching optimal or acceptable sub-optimal solutions in the space of solutions defined by the ranges or sets defined in step 204 (see FIG. 2A) for every constraint defined in step 204 (see FIG. 2A), the scheduling system 104 (see FIG. 1) identifies new values for the constraints as a best choice according to predefined criteria. These identified new values are substituted in step 220 for the constraint values used in the most recently executed workload execution plan. The scheduling system 104 (see FIG. 1) then stores the new values identified in step 220 in data repository 114 (see FIG. 1), which resides in a computer data storage unit coupled to computing system 102 (see FIG. 1). Optionally, scheduling system 104 (see FIG. 1) presents the new values identified in step 220 to a user (e.g., via an ad hoc report that is printed by a printing device or displayed on a display device).

Depending on the particular algorithm used, step 220 may be described as a loop that includes steps 216 and 218 with an exit condition (not shown) (i.e., the optimal or acceptable sub-optimal solution is found) or as a different non-loop technique that considers the space of solutions (e.g., through mathematical means), looking for the optimal or acceptable sub-optimal solution. As used herein, an acceptable sub-optimal solution is a solution that meets predefined criteria.

In step 222, scheduling system 104 (see FIG. 1) generates the next workload execution plan 110 (see FIG. 1) using the new values for each constraint and executes the generated workload execution plan on target computing systems. Optionally, scheduling system 104 (see FIG. 1) presents the next workload execution plan generated in step 222 to a user (e.g., via an ad hoc report that is printed by a printing device or displayed on a display device). If inquiry step determines in step 224 that the workload scheduling optimization process continues, then the process of FIGS. 2A-2B repeats starting at step 210; otherwise the process of FIGS. 2A-2B ends at step 226. If the user decides that a new execution plan for another timeframe is needed and the scheduling system 104 (see FIG. 1) receives an indication of that need for a new execution plan for another timeframe, then step 224 determines that the workload scheduling optimization process continues. If the user decides that a new execution plan for another timeframe is not needed and the scheduling system receives no indication of a need for a new execution plan for another timeframe, then step 224 determines that the workload scheduling optimization process does not continue.

The benefit of the overall solution provided by the process of FIGS. 2A-2B is that the corrections made by the scheduling system automatically will be made persistent through the definition of the constraints, which in time generate execution plans that are closer and closer to the optimal one.

In contrast to conventional monitoring systems that take action at plan execution time to react to conditions of non-optimal resource usage, the scheduling mechanism described herein freezes the optimal solution within the definitions of the constraints set for each task. Such definitions of the constraints, which are generated from the above-described process, ensure that every time an execution plan is generated, the execution plan is optimal. Thus, no real-time monitoring activity is required because all tasks are shaped in advance to produce an optimized workload at scheduling time rather than during the execution of the tasks.

### Computing System

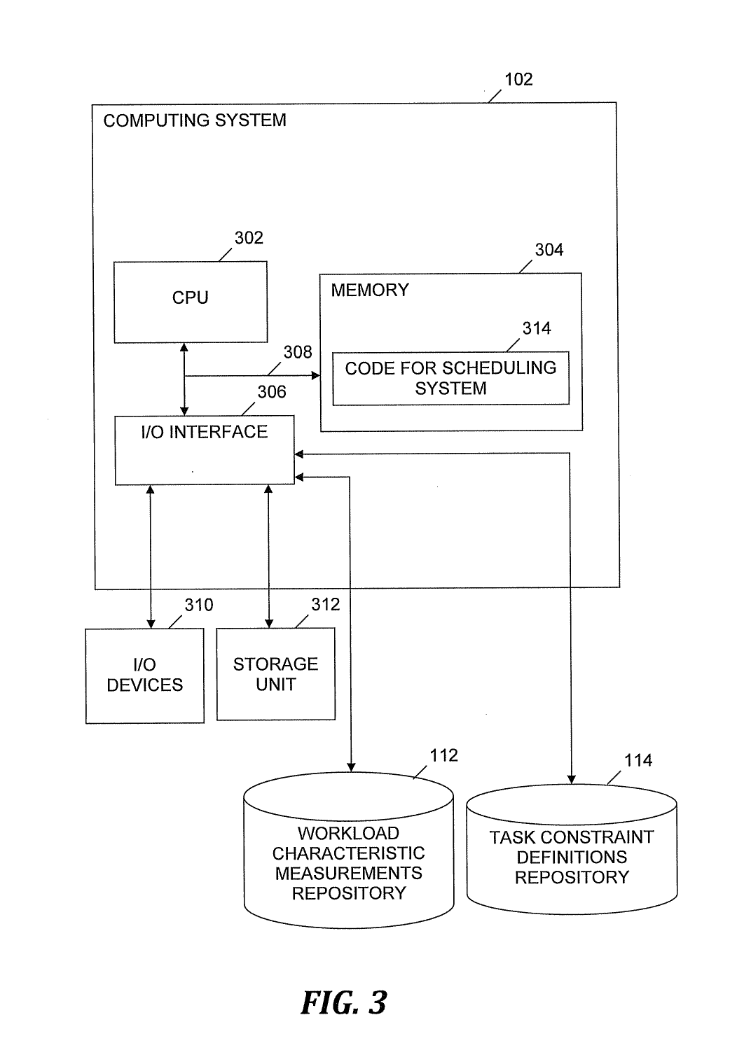

FIG. 3 is a computing system that is included in the system of FIG. 1 and that implements the process of FIGS. 2A-2B, in accordance with embodiments of the present invention. Computing system 102 generally comprises a central processing unit (CPU) 302, a memory 304, an input/output (I/O) interface 306, and a bus 308. Further, computing system 102 is coupled to I/O devices 310, a computer data storage unit 312, workload characteristic measurements repository 112 and task constraints definitions repository 114. CPU 302 performs computation and control functions of computing system 102. CPU 302 may comprise a single processing unit, or be distributed across one or more processing units in one or more locations (e.g., on a client and server).

Memory 304 may comprise any known type of computer data storage and/or transmission media, including bulk storage, magnetic media, optical media, random access memory (RAM), read-only memory (ROM), a data cache, a data object, etc. In one embodiment, cache memory elements of memory 304 provide temporary storage of at least some program code in order to reduce the number of times code must be retrieved from bulk storage during execution. Moreover, similar to CPU 302, memory 304 may reside at a single physical location, comprising one or more types of data storage, or be distributed across a plurality of physical systems in various forms. Further, memory 304 can include data distributed across, for example, a local area network (LAN) or a wide area network (WAN).

I/O interface 306 comprises any system for exchanging information to or from an external source. I/O devices 310 comprise any known type of external device, including a display device (e.g., monitor), keyboard, mouse, printer, speakers, handheld device, facsimile, etc. In one embodiment, an I/O device 310 such as a display device displays the task constraints defined in step 204 (see FIG. 2A) and modified in step 216 (see FIG. 2B), the contributions of each task to workload characteristics, as determined in step 210 (see FIG. 2B), the expected return evaluated in step 218 (see FIG. 2B), and/or the optimal or acceptable sub-optimal solution determined in step 220 (see FIG. 2B). Bus 308 provides a communication link between each of the components in computing system 102, and may comprise any type of transmission link, including electrical, optical, wireless, etc.

I/O interface 306 also allows computing system 102 to store and retrieve information (e.g., program instructions or data) from an auxiliary storage device such as computer data storage unit 312. The auxiliary storage device may be a non-volatile storage device, such as a hard disk drive or an optical disc drive (e.g., a CD-ROM drive which receives a CD-ROM disk). Computer data storage unit 312 is, for example, a magnetic disk drive (i.e., hard disk drive) or an optical disk drive.

Memory 304 includes computer program code 314 that provides the logic for automatically optimizing workload scheduling (e.g., the process of FIGS. 2A-2B). Further, memory 304 may include other systems not shown in FIG. 3, such as an operating system (e.g., Linux) that runs on CPU 302 and provides control of various components within and/or connected to computing system 102.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “system” (e.g., system 102). Furthermore, the present invention may tale the form of a computer program product embodied in any tangible medium of expression (e.g., memory 304 or computer data storage unit 312) having computer-usable program code (e.g., code 314) embodied in the medium.

Any combination of one or more computer-usable or computer-readable medium(s) (e.g., memory 304 and computer data storage unit 312) may be utilized. The computer-usable or computer-readable medium may be, for example but not limited to, an electronic, magnetic, optical, electromagnetic, infrared or semiconductor system, apparatus, device or propagation medium. A non-exhaustive list of more specific examples of the computer-readable medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code (e.g., code 314) for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer (e.g., computing system 102), partly on the user's computer, as a stand-alone software package, partly on the user's computer and partly on a remote computer or entirely on the remote computer or server. In the latter scenario, the remote computer may be connected to the user's computer through any type of network (not shown), including a LAN, a WAN, or the connection may be made to an external computer (e.g., through the Internet using an Internet Service Provider).

The present invention is described herein with reference to flowchart illustrations (e.g., FIGS. 2A-2B) and/or block diagrams of methods, apparatus (systems) (e.g., FIG. 1 and FIG. 3), and computer program products according to embodiments of the invention. It will be understood that each block of the flowchart illustrations and/or block diagrams, and combinations of blocks in the flowchart illustrations and/or block diagrams, can be implemented by computer program instructions (e.g., code 314). These computer program instructions may be provided to a processor (e.g., CPU 302) of a general purpose computer (e.g., computing system 102), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium (e.g., memory 304 or computer data storage unit 312) that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer (e.g., computing system 102) or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in FIG. 1 and FIGS. 2A-2B illustrate the architecture, functionality, and operation of possible implementations of systems, methods, and computer program products according to various embodiments of the present invention. In this regard, each block in the flowchart or block diagrams may represent a module, segment, or portion of code (e.g., code 314), which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer-implemented method of automatically optimizing workload scheduling, comprising:
receiving, by a computing system, a plurality of target values for a plurality of workload characteristics, wherein said target values are user-defined and are characteristics of a workload in an information technology infrastructure;
receiving, by said computing system, a plurality of constraint specifications, wherein each constraint specification is user-defined and includes a range of values or a set of values;
initiating, by said computing system, subsequent to said receiving said plurality of constraint specifications and subsequent to said receiving said plurality of target values for said plurality of workload characteristics, a generation of a first execution plan;
selecting, by said computing system and subsequent to said initiating said generation of said first execution plan, a plurality of initial values for a plurality of constraints, wherein each constraint of said plurality of constraints is specified by a constraint specification of said plurality of constraint specifications, and wherein each constraint of said plurality of constraints constrains a plurality of tasks included in said workload;
generating, by said computing system and subsequent to said selecting said plurality of initial values, said first execution plan;
executing, by said computing system and subsequent to said generating said first execution plan, said first execution plan, wherein said executing said first execution plan includes determining a plurality of measurements of said plurality of workload characteristics;
determining, by said computing system and subsequent to said executing said first execution plan, a plurality of contributions, wherein said plurality of contributions indicates a plurality of differences between said plurality of measurements of said plurality of workload characteristics and said plurality of target values;
storing, by said computing system, in a computer data storage unit and subsequent to said determining said plurality of contributions, said plurality of contributions;
initiating, by said computing system and subsequent to said determining said plurality of contributions, a generation of a next execution plan;
modifying, by said computing system and subsequent to said initiating said generation of said next execution plan, said plurality of constraints, wherein a result of said modifying is a plurality of modified values of said plurality of constraints, and wherein each modified value is specified by a constraint specification of said plurality of constraint specifications;
evaluating, by said computing system and subsequent to said modifying said plurality of constraints, a plurality of changes of said plurality of workload characteristics, wherein said plurality of changes is based on said plurality of modified values of said plurality of constraints for each time period of a plurality of predefined time periods in a duration of said next execution plan;
determining, by said computing system and subsequent to said evaluating said plurality of changes, a solution in a space of solutions defined by said plurality of constraint specifications, wherein said solution is selected from the group consisting of: an optimal solution and an acceptable sub-optimal solution, wherein a result of said determining said solution is a plurality of new values for said plurality of constraints;
storing, by said computing system, in a computer data storage medium and subsequent to said determining said solution, said plurality of new values for said plurality of constraints;
replacing, by said computing system and subsequent to said determining said solution, said plurality of initial values with said plurality of new values;
generating, by said computing system and subsequent to said replacing said plurality of initial values, said next execution plan, wherein said next execution plan includes said plurality of new values as said plurality of constraints; and
executing, by said computing system and subsequent to said generating said next execution plan, said next execution plan.

2. The method of claim 1, further comprising iteratively repeating, in a loop, said determining said plurality of contributions, said storing said plurality of contributions, said initiating said generation of said next execution plan, said modifying said plurality of constraints, said evaluating said plurality of changes of said plurality of workload characteristics, said determining said optimal solution or said acceptable sub-optimal solution, said storing said plurality of new values, said replacing said plurality of initial values with said plurality of new values, said generating said next execution plan, and said executing said next execution plan until said solution satisfies predefined criteria for being said optimal solution or said acceptable sub-optimal solution.

3. The method of claim 2, wherein said determining said plurality of contributions is performed prior to said iteratively repeating, wherein said determining said plurality of contributions includes determining multiple sets of contributions included in said plurality of contributions, and wherein each set of contributions is based on a corresponding time period of a plurality of predefined time periods in a duration of said first execution plan.

4. The method of claim 2, wherein said determining said plurality of contributions is performed in a current iteration of said loop, wherein said determining said plurality of contributions includes determining multiple sets of contributions included in said plurality of contributions, wherein each set of contributions is based on a corresponding time period of a plurality of predefined time periods in a duration of a prior execution plan, and wherein said prior execution plan was executed prior to said current iteration of said loop.

5. The method of claim 1, wherein said generating said next execution plan includes generating an optimized execution plan at scheduling time and not during an execution of said plurality of tasks.

6. The method of claim 1, wherein each workload characteristic of said plurality of workload characteristics is selected from the group consisting of:
an average number of tasks executed per unit of time,
central processing unit usage,
memory consumption,
input/output (I/O) read rate, and
I/O write rate.

7. The method of claim 1, wherein each constraint specification of said plurality of constraint specifications is selected from the group consisting of:
a range of dates for a date on which a task of said plurality of tasks is expected to run,
a range of times for a time at which said task is expected to run,
a range of frequency rates for a frequency rate for repeating an execution of said task,
a maximum value of a priority of said task, and
a minimum value of said priority of said task.

8. A computing system comprising a processor coupled to a computer-readable memory unit, said memory unit comprising a software application, said software application comprising instructions that when executed by said processor implement the method of claim 1.

9. A computer program product, comprising a computer-usable medium having a computer-readable program code embodied therein, said computer-readable program code comprising an algorithm adapted to implement the method of claim 1.
